(19) United States
(12) Patent Application Publication
(10) Pub. No.: US 2013/0176740 A1
(43) Pub. Date: Jul. 11, 2013

(54) LENS DEVICE FOR FOCUSING OR DIFFUSING LIGHT BEAMS

(71) Applicant: Wen-Sung LEE, Taichung City (TW)

(72) Inventor: Wen-Sung LEE, Taichung City (TW)

(21) Appl. No.: 13/345,759

(22) Filed: Jan. 9, 2012

(51) Int. Cl. F21V 5/04

(52) U.S. Cl. 362/335

(57) ABSTRACT

A lens device for focusing or diffusing light beams includes a lens body having a flat sheet, a first convex lens extruded away from one end of the flat sheet, a second convex lens extruded away from another end of the flat sheet, the distance between an apex of the first convex lens and the center of the bottom of the first convex lens being larger than the distance between an apex of the second convex lens and the center of the bottom of the second convex lens. Although the surface of the first convex lens is not flawless after the compression molding and light beams cannot be refracted uniformly by the first convex lens, the second convex lens refracts the light beams for pre-adjusting before the light beams are refracted by the first convex lens.

### BACKGROUND OF THE INVENTION

1. Field of the Invention

The present invention relates to a lens device and more particularly to a lens device for focusing or diffusing light beams.

2. Description of Related Art

Undoubtedly, lighting fixture is a necessary apparatus for indoor space or in the dark. The lighting fixture has a conventional lens device which is used to focus or diffuse a plurality of light beams from the lighting fixture. When the lighting fixture is designed as a searchlight, the conventional lens device is designed to focus the light beams from the lighting fixture. In contrast, when the lighting fixture is designed as a street light, the conventional lens device is designed to diffuse the light beams from the lighting fixture. Therefore, the conventional lens device plays an important role in this field.

The conventional lens device is generally a plano-convex lens and is made from an optical gel. The optical gel is poured into a mold for forming the conventional lens device by an injection molding or a compression molding. However, the conventional lens device has a disadvantage as following:

When the optical gel is under the injection molding or the compression molding, a pressure of the injection molding or the compression molding is often difficult to control for making one flawless surface of the conventional lens device. Therefore, the curvature of the surface of the conventional lens device is often not uniform and the light beams cannot be refracted uniformly by the conventional lens device.

The present invention has arisen to mitigate and/or obviate the disadvantages of the conventional. Further benefits and advantages of the present invention will become apparent after a careful reading of the detailed description with appropriate reference to the accompanying drawings.

### SUMMARY OF THE INVENTION

The main objective of the present invention is to provide an improved lens device.

To achieve the objective, a lens device for focusing or diffusing light beams comprises a lens body having a flat sheet, a first convex lens assembled to one end of the flat sheet, a second convex lens assembled to another end of the flat sheet, the first convex lens extruded away from one end of the flat sheet, the second convex lens extruded away from another end of the flat sheet, the distance between an apex of the first convex lens and the center of the bottom of the first convex lens being defined as a first depth, the distance between an apex of the second convex lens and the center of the bottom of the second convex lens being defined as a second depth, the second depth being smaller than a half of the first depth. Wherein, the second depth is smaller than ten percents of the first depth for the best illumination; the curvature of the first convex lens is larger than the curvature of the second convex lens; a light source is located near the lens body; the light source is corresponding to the apex of the second convex lens.

Thereby, although the surface of the first convex lens is not flawless after the injection molding or the compression molding and the light beams cannot be refracted uniformly by the first convex lens, the second convex lens could refract the light beams for pre-adjusting before the light beams are refracted by the first convex lens.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a lens device for focusing or diffusing light beams of the present invention;

FIG. 2 is a side view of the lens device for focusing or diffusing light beams of the present invention;

FIG. 3 is a side view for showing a plurality of light beams to be focusing; and

FIG. 4 is a side view for showing the light beams to be diffusing.

### DETAILED DESCRIPTION OF THE INVENTION

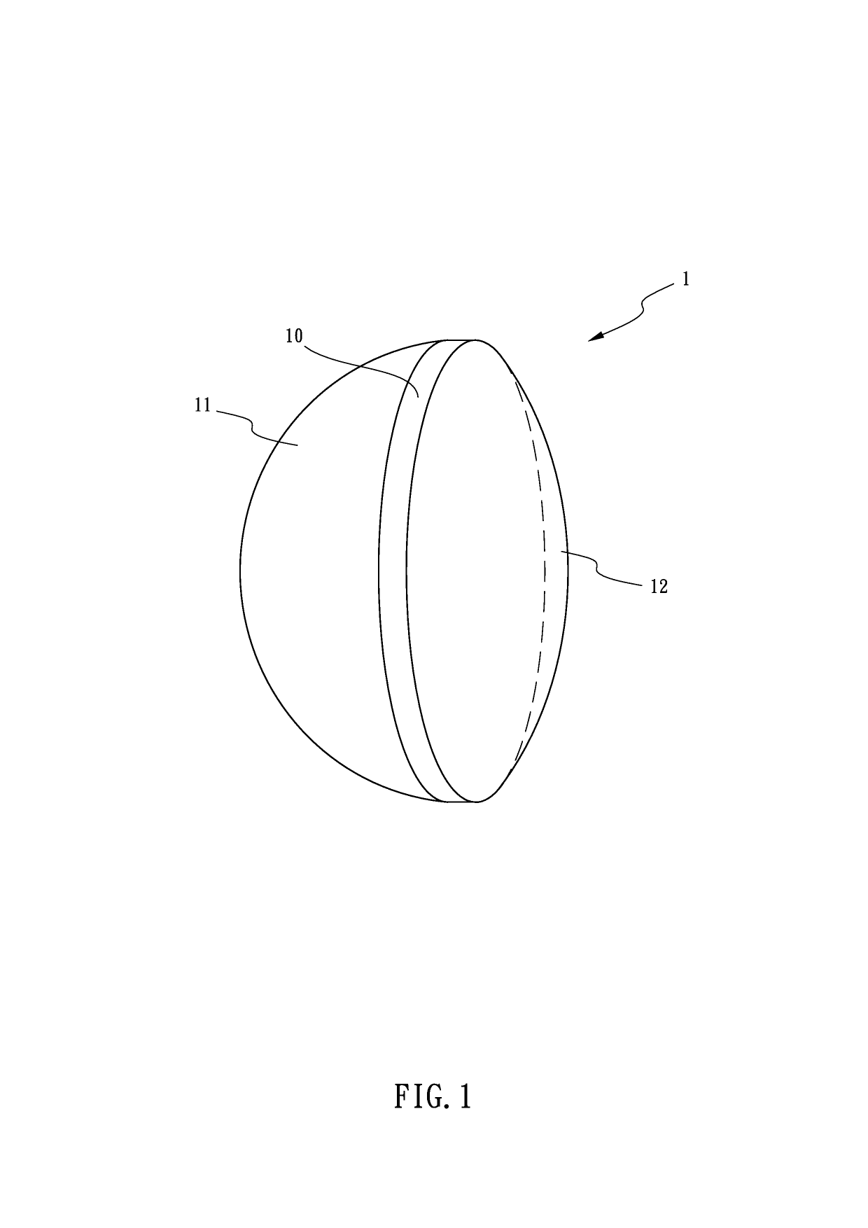

Referring to FIGS. 1-3, a lens device for focusing or diffusing light beams in accordance with the present invention comprises a lens body 1. The lens body 1 has a flat sheet 10 which is a transparent. The flat sheet 10 has a thickness d0. A first convex lens 11 is assembled to one end of the flat sheet 10. A second convex lens 12 is assembled to another end of the flat sheet 10. The first convex lens 11 is extruded away from one end of the flat sheet 10. The second convex lens 12 is extruded away from another end of the flat sheet 10. The distance between an apex of the first convex lens 11 and the center of the bottom of the first convex lens 11 is defined as a first depth d11. The distance between an apex of the second convex lens 12 and the center of the bottom of the second convex lens 12 is defined as a second depth d12. The second depth d12 is smaller than the first depth d11. The curvature of the first convex lens 11 is larger than the curvature of the second convex lens 12. A light source 2 (which is a LED in this embodiment) is located near the lens body 1. The light source 2 is corresponding to the apex of the second convex lens 12.

The second depth d12 is usually smaller than a half of the first depth d11. In this embodiment, the second depth d12 is smaller than ten percents of the first depth d11 for the best illumination.

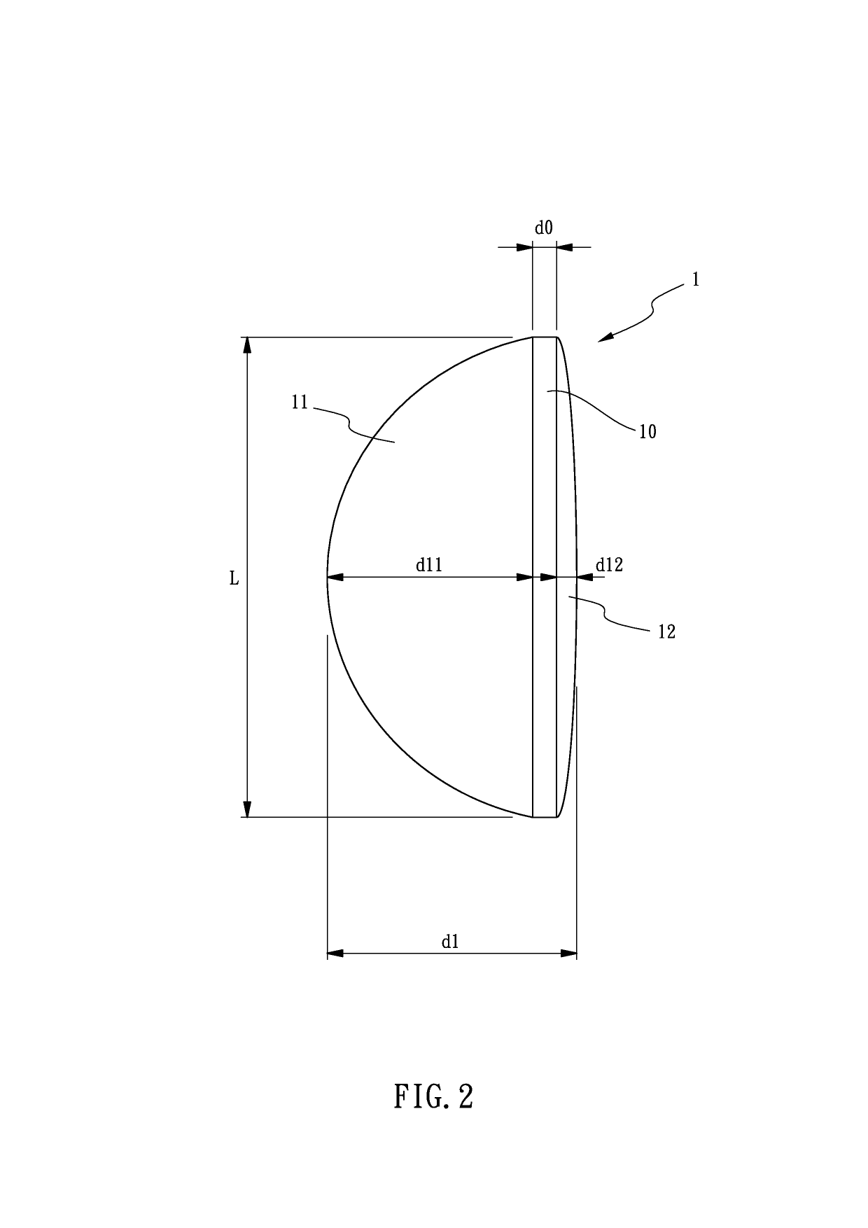

Referring to FIG. 2, the lens body 1 has a diameter L. The length of the diameter L is 27.20 millimeters. The length of the thickness d0 of the flat sheet 10 is 1.54 millimeters. The distance between the apex of the first convex lens 11 and the apex of the second convex lens 12 is defined as a whole depth d1. The length of the whole depth d1 is 11 millimeters.

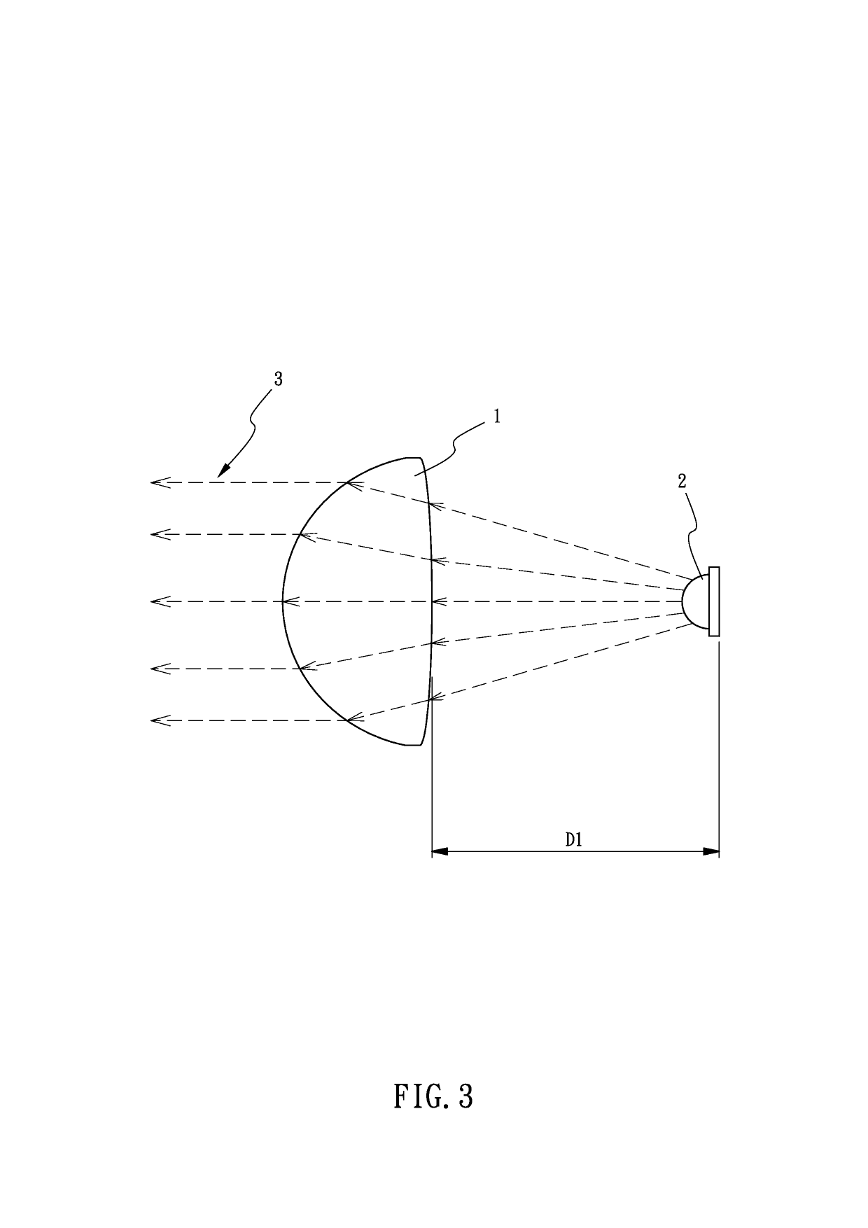

Referring to FIG. 3, when the light source 2 is moved away from the apex of the second convex lens 12 until the distance between the light source 2 and the apex of the second convex lens 12 is 17 millimeters which is defined as a focusing distance D1, a plurality of light beams 3 from the light source 2 is refracted by the second convex lens 12 and directly passes through the flat sheet 10 into the first convex lens 11. Thereafter, the light beams 3 are refracted by the first convex lens 11 to one definite direction so that the light beams 3 are focused. Under this arrangement, the lens body 1 might be used for a searchlight.

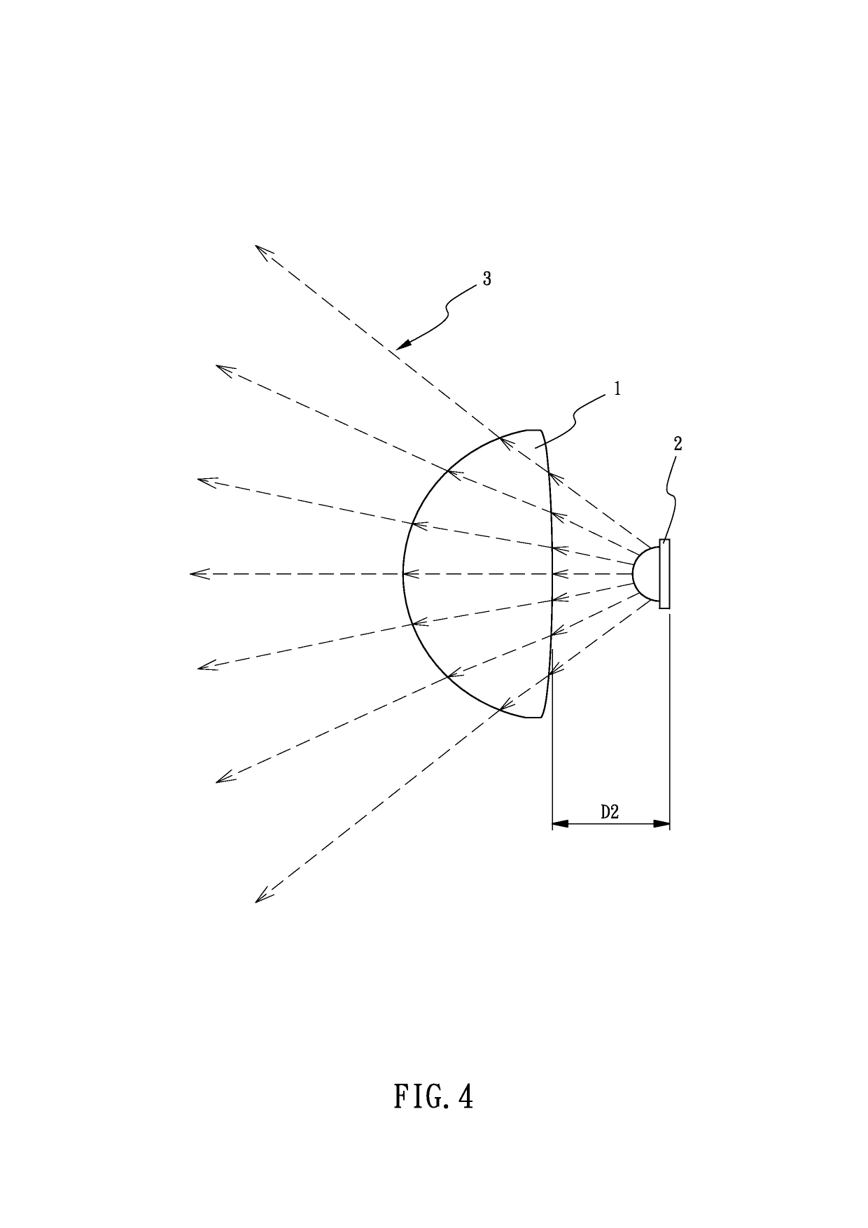

Referring to FIG. 4, when the light source 2 is moved toward the apex of the second convex lens 12 until the distance between the light source 2 and the apex of the second convex lens 12 is 6.5 millimeters which is defined as a diffusing distance D2, the light beams 3 from the light source 2 is refracted by the second convex lens 12 and directly passes through the flat sheet 10 into the first convex lens 11. Thereafter, the light beams 3 are refracted by the first convex lens 11 to divergent directions so that the light beams 3 are diffused. Under this arrangement, the lens body 1 might be used for a street light.

All in all, although the surface of the first convex lens 11 is not flawless after the injection molding or the compression molding and the light beams 3 cannot be refracted uniformly by the first convex lens 11, the second convex lens 12 could refract the light beams 3 for pre-adjusting before the light beams 3 are refracted by the first convex lens 11.

Although the invention has been explained in relation to its preferred embodiment, it is to be understood that many other possible modifications and variations can be made without departing from the spirit and scope of the invention as hereinafter claimed.

What is claimed is:

1. A lens device for focusing or diffusing light beams comprising:
a lens body having a flat sheet, a first convex lens assembled to one end of the flat sheet, a second convex lens assembled to another end of the flat sheet, the first convex lens extruded away from one end of the flat sheet, the second convex lens extruded away from another end of the flat sheet, the distance between an apex of the first convex lens and the center of the bottom of the first convex lens being defined as a first depth, the distance between an apex of the second convex lens and the center of the bottom of the second convex lens being defined as a second depth, the second depth being smaller than a half of the first depth.

2. The lens device for focusing or diffusing light beams as claimed in claim 1, wherein the second depth is smaller than ten percents of the first depth for the best illumination.

3. The lens device for focusing or diffusing light beams as claimed in claim 1, wherein the curvature of the first convex lens is larger than the curvature of the second convex lens.

4. The lens device for focusing or diffusing light beams as claimed in claim 1, wherein a light source is located near the lens body;
the light source is corresponding to the apex of the second convex lens.
